(19) United States
(12) Patent Application Publication
(10) Pub. No.: US 2021/0058742 A1
(43) Pub. Date: Feb. 25, 2021

(54) TECHNIQUES FOR LOCATION-BASED ALERT OF AVAILABLE APPLICATIONS

(71) Applicant: Lenovo (Singapore) Pte. Ltd., Singapore (SG)

(72) Inventors: Nathan J. Peterson, Oxford, NC (US); Russell Speight VanBlon, Raleigh, NC (US); John C. Mese, Cary, NC (US); Arnold S. Weksler, Raleigh, NC (US); Mark Patrick Delaney, Raleigh, NC (US)

(21) Appl. No.: 16/544,407

(22) Filed: Aug. 19, 2019

(51) Int. Cl. H04W 4/029; H04W 4/02; H04W 68/00; H04W 4/12

(52) U.S. Cl. CPC H04W 4/029; H04W 4/12; H04W 68/00; H04W 4/026

(57) ABSTRACT

In one aspect, a first device includes at least one processor and storage accessible to the at least one processor. The storage may include instructions executable by the at least one processor to identify a location of a user device, access a data structure correlating locations to applications, identify at least a first application in the data structure using the location of the user device, and generate a message presentable on the user device alerting the user of the availability of the first application.

### FIELD

The present application relates to technically inventive, non-routine solutions that are necessarily rooted in computer technology and that produce concrete technical improvements.

### BACKGROUND

As recognized herein, there are many scenarios when a user is at a place but he may be unaware of available capabilities associated with that place. For example, the user may be at a restaurant but not know that the restaurant has an application available for ordering food, or that third party applications related to restaurant rewards likewise are available. Instead, it is typically required that the user first download the application, which then may generate proximity-based pop-ups, but this requires the user to have pre-knowledge of the availability of the application in the first place.

There are currently no adequate solutions to the foregoing computer-related, technological problem.

### SUMMARY

Accordingly, in one aspect a first device includes at least one processor and storage accessible to the at least one processor. The storage includes instructions executable by the processor to identify a location of a user device, access a data structure correlating locations to applications, and, using the location of the user device, identify at least a first application in the data structure. The instructions are executable to generate a message presentable on the user device alerting the user of the availability of the first application, which may be presented on the user device.

If desired, the first device may include a wireless transceiver accessible to the processor, where a signal from the wireless transceiver may be used to identify the location of the user device.

In some implementations, the instructions may be executable to, responsive to identifying the first application, identify a number of times the user device has previously been at the location. The number of times of previous locality typically is at least one time. The instructions may be executable to, responsive to the number of times satisfying a threshold, present the message on the user device, and responsive to the number of times not satisfying the threshold, not present the message on the user device.

The first device may include and/or be implemented by the user device. The first device may include and/or be implemented by a network server that communicates with the user device.

In another aspect, a computer readable storage medium (CRSM) that is not a transitory signal includes instructions executable by at least one processor to identify a wireless signal from a computer electronics (CE) device received at a user device. The instructions also are executable to access a data structure correlating wireless signals to applications, and using the wireless signal from the CE device, identify at least a first application in the data structure. The instructions are executable to generate a message presentable on the user device alerting the user of the availability of the first application.

In another aspect, a method includes identifying at least one of: a location of a user device, and/or at least one characteristic of at least one wireless signal received by the user device, and responsive to the identifying, alerting the user device that at least a first application is available for downloading.

When identifying the location, the location may include, e.g., a latitude and longitude or a place name.

When identifying the characteristic of at least one wireless signal received by the user device, the characteristic may be, e.g., a network address or a wireless signal propagation characteristic.

Additionally, in some embodiments the alerting the user device that at least the first application is available for downloading may include presenting a selector on a display that is selectable to initiate a download of the first application.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 is a flow chart of example logic consistent with present principles;

FIG. 4 is a schematic diagram of an example data structure for correlating locations and other information to applications;

FIG. 5 is a flow chart of additional example logic consistent with present principles;

FIG. 6 is a screen shot of an example user interface (UI) that may be presented on a display of a user device to alert the user of the availability of relevant application(s) based on the user's location;

FIG. 7 is a screen shot of an example UI that may be presented on a display of a user device to alert the user of the availability of relevant application(s) based on detected wireless signals indicating nearby devices associated with respective applications;

FIG. 8 is a schematic diagram of an example data structure for correlating wireless signal types to applications associated with device emitting the wireless signals; and

FIG. 9 is a screen shot of an example UI for configuring one or more settings of a user device consistent with present principles.

### DETAILED DESCRIPTION

Present principles afford notification of available applications (“apps”) that are tagged in an app store as having some association with the place or location a user with his or her user device is at, as indicated by, e.g., global positioning satellite (GPS) information from a GPS receiver in the user device. Present application(s) the user doesn't have on his or her user device and may not even know exist, but are relevant to the user's current location, may include, for example, restaurant apps and related third party apps such as Stealz (which affords dining credits among other things). In addition to retail applications, present principles may apply to, for example, a hiking trail, in which case based on location data indicating the user device is on the trail, the app store suggests apps such as apps that have a hiking trail map for the particular trail.

As discussed further below, if the user visits a location many times, a threshold number of visits may be used prior to notifying the user of the existence of a relevant map, to avoid constantly prompting the user or causing him or her to become numb to the prompts. For example, the user might only be notified of a relevant location app after three visits to a relevant location to maximize value to the user for locations to which he frequently peregrinates. When identifying the location, the location may include, e.g., a latitude and longitude or a place name.

As also discussed further below, if the user device detects a wireless signal specific to a certain manufacturer or type of device, logic may suggest downloading the app that may have the ability to control that device. As an example, if Wi-fi or a wireless signal that indicates “Roku direct” is detected, which might be the signal typically used for first installation of a Roku stick, the user device may suggest an app specific to Roku, such as a Roku installation app. Similarly, if the user device detects a media access control (MAC) address in a wireless signal that is associated with Amazon (a manufacturer) or an Amazon Echo (a device type), present principles may suggest an Amazon app, e.g., to control the Echo device. Also in some examples, suggesting apps based on manufacturer or type of device may be limited to occurring at locations of certain location types, such as residential or office building locations, so as to not annoy a user when at other location types such as a retail store or restaurant.

When identifying the characteristic of a wireless signal received by the user device, the characteristic may be, e.g., a network address or a wireless signal propagation characteristic such as, for example, frequency, phase, amplitude, protocol-dependent characteristics, and combinations thereof.

Note that a notification of a relevant app need not take place immediately, upon determining that the user is in a location that is associated with an app or upon detecting a wireless signal that implies an associated app. The app store, typically based on one or more network servers, may wait a period of time, e.g., at the end of the week the app store might notify the user of all apps relevant to places or signals the user encountered in the prior week.

The suggestions could be based on an application tagging itself as associated with a type of business, business name, general geographic locations, as well as applications that others have installed based on these contexts.

With respect to any computer systems discussed herein, a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino Calif., Google Inc. of Mountain View, Calif., or Microsoft Corp. of Redmond, Wash. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any general purpose single- or multi-chip processor that can execute logic by means of various lines such as address lines, data lines, and control lines and registers and shift registers. Moreover, any logical blocks, modules, and circuits described herein can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, CD ROM or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (that is not a transitory, propagating signal per se) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

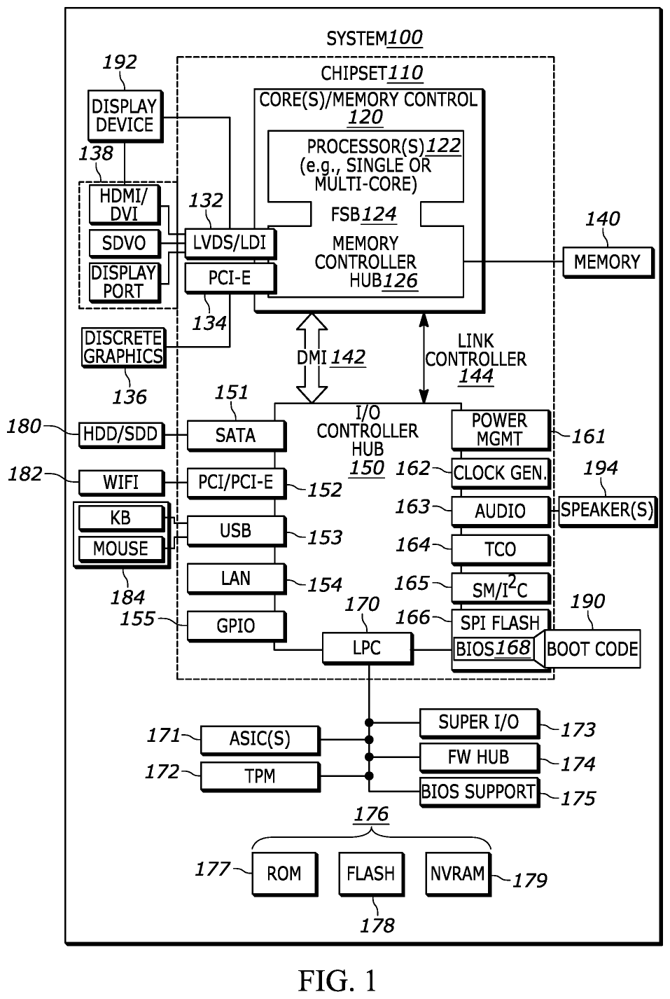

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though not shown for simplicity, in some embodiments the system 100 may include a gyroscope that senses and/or measures the orientation of the system 100 and provides input related thereto to the processor 122, as well as an accelerometer that senses acceleration and/or movement of the system 100 and provides input related thereto to the processor 122. Still further, the system 100 may include an audio receiver/microphone that provides input from the microphone to the processor 122 based on audio that is detected, such as via a user providing audible input to the microphone, and a camera that gathers one or more images and provides input related thereto to the processor 122. The camera may be a thermal imaging camera, an infrared (IR) camera, a digital camera such as a webcam, a three-dimensional (3D) camera, and/or a camera otherwise integrated into the system 100 and controllable by the processor 122 to gather pictures/images and/or video. Also, the system 100 may include a GPS transceiver that is configured to communicate with at least one satellite to receive/identify geographic position information and provide the geographic position information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

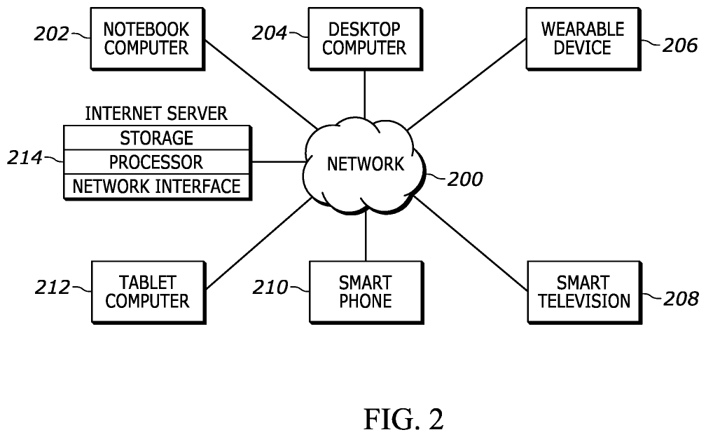

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 are configured to communicate with each other over the network 200 to undertake present principles.

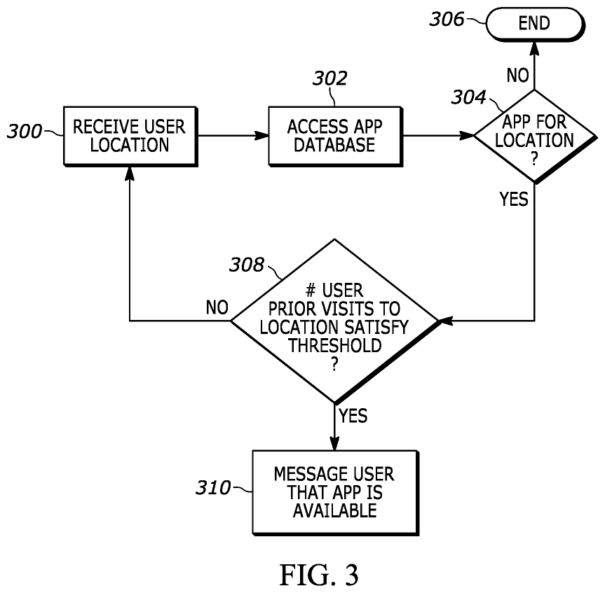

FIG. 3 illustrates example overall. Note that while FIG. 3 and other flow charts may illustrate logic in flow chart format, state logic or other equivalent logic may be used. The logic of FIG. 3 may be implemented by a user device, a network server in communication with the network device, a third party consumer electronics device, and combinations thereof.

Commencing at block 300, user location is received. The user location may be inferred to be the location of a user device as indicated by, e.g., GPS information from the user device, although other location techniques may be used. For example, face recognition may be used to recognize the user and correlate the user location to the location of the imaging camera.

Moving to block 302, knowing the user location the logic accesses an app database either on the user device or on a network server or other appropriate network location. Based on entries in the database correlated to the location of the user, it is determined at decision diamond 304 whether the app database contains any apps indicated as being correlated to the location. If not, the logic ends at state 306.

On the other hand, if it is determined at decision diamond 304 that the app database contains one or more apps indicated as being correlated to the location, indications of those apps (there may be more than one) may be provided to the user. Note that prior to accessing the app store or after accessing the app stored, the logic may check the user device for apps already installed in the user device and will not generate advisory availability messages to the user device of any app in the app store already present on the user device.

However, as shown in FIG. 3 an intermediate step may be executed to avoid potentially barraging the user with app recommendations. Specifically, as indicated at decision diamond 308, it may be determined whether the user has visited the location a discrete number of previous times that satisfies a threshold, e.g., three visits. The threshold may also include a time window, e.g., three visits in the past month. A “discrete visit” may be determined by the number of times prior user location data indicates the user was within a threshold distance of the current location, e.g., fifty yards, and then moved away from the current location by a threshold distance, e.g., one mile, for at least a threshold period, e.g., one day.

A positive test at decision diamond 308 causes the logic to move to block 310 to generate a message to the user that one or more apps correlated to his current location are available. When the logic is executed by the server, the server may signal the user device to present the message. As alluded to above, messaging may be delayed if desired, such that a period of time elapses between decision diamond 308 and block 310 so that, for example, messages concerning available apps may be allowed to accumulate for a period of time, e.g., a day or a week, prior to presenting them to the user.

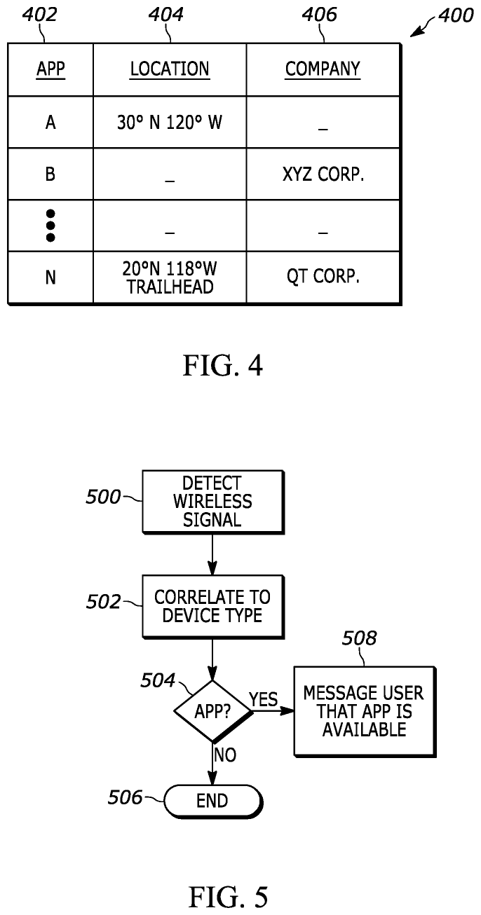

FIG. 4 illustrates an example data structure 400 that may be used at block 302 in FIG. 3. Applications are listed in a column 402 in FIG. 4 along with corresponding locations 404 and if desired company names 406, either of the app maker or of the company that might own a building in which the user is located.

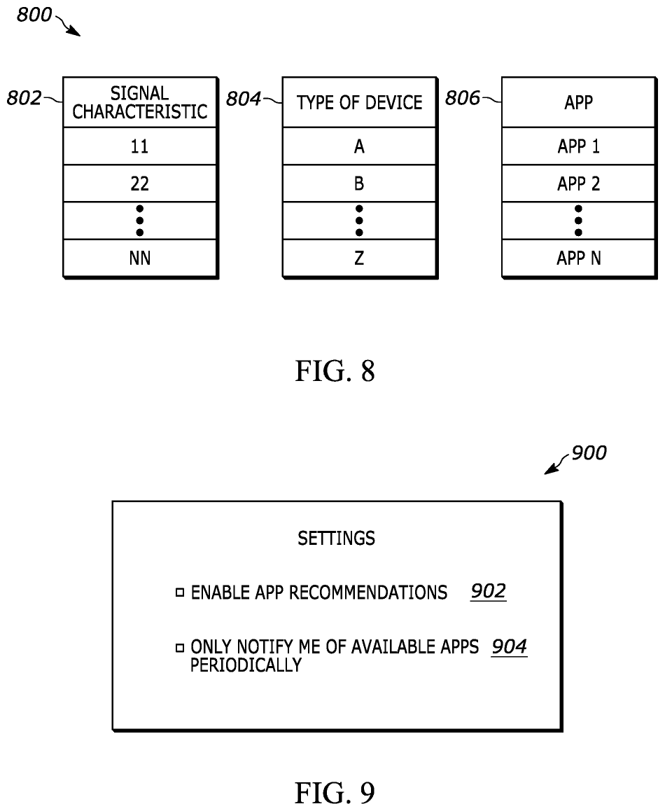

FIG. 5 illustrates logic that may tie advisory messages about available apps to the detection of wireless signals. At block 500 a wireless signal may be detected to identify the wireless signal, which is typically sent from a computer electronics (CE) device and received at the user device. Moving to block 502 the wireless signal may be correlated to a device type. This may be done by accessing a data structure correlating wireless signals to applications, such as the data structure shown in FIG. 8 and described further below. Using the wireless signal from the CE device, at decision diamond 504 it is determined whether any apps associated with the wireless signal/CE device type are in the app store. If not, the logic ends at state 506, but otherwise the logic messages the user at block 508 as to the availability of the app(s).

It is to be understood that the time delay feature discussed above in relation to FIG. 3 may apply to the logic of FIG. 5. It is to be further understood that a “number of hits” feature analogous to state 308 in FIG. 3 may be implemented in the logic of FIG. 5. That is, a message may be generated at block 508 only if the same wireless signal has been received by the user device a threshold number of times previously, typically receptions separated from each other by a threshold amount, e.g., one day.

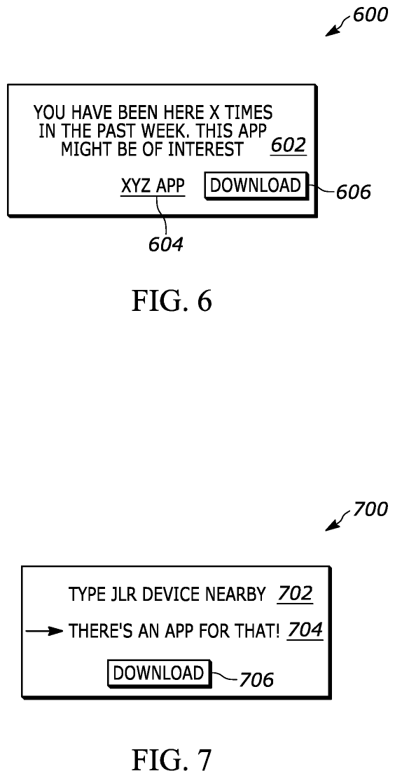

FIG. 6 illustrates a UI 600 that may be presented on a user device pursuant to the logic of FIG. 3 above. As shown, the UI 600 may include an audible or visual prompt 602 indicating that the user has been at the current location a specified number of times during a specified period, and that the app indicated at 604 might be of interest. A download selector 606 can be presented to allow the user to download the app.

FIG. 7 illustrates a UI 700 that may be presented on a user device pursuant to the logic of FIG. 7 above. As shown, the UI 700 may include an audible or visual prompt 702 indicating that a device of a particular type is nearby, along with a prompt 704 that the app may be downloaded. A download selector 706 can be presented to allow the user to download the app.

FIG. 8 illustrates an example data structure 800 that may be used at block 502 in FIG. 5. Signal characteristics are listed in a column 802 in FIG. 8 along with corresponding types of devices 804 and if desired the names 806 of applications corresponding to the device types/signal characteristics. A signal characteristic may be, e.g., a network address, a frequency, a phase, an amplitude, a type of code division, a multiplexing, etc. and combinations thereof.

Now describing FIG. 9, an example UI 900 that may be presented on the display of a user device is shown. The UI 900 may be used to configure one or more settings of the user device in order to undertake present principles. Each setting that is shown may be selected by directing touch or cursor input to the adjacent check box.

As shown, the UI 900 may include a first setting 902 that is selectable to enable or configure the device to provide app suggestions consistent with present principles. For example, the setting 902 may be selected to set the device to undertake the logic of FIG. 3 and/or FIG. 5, as well as to present the UIs of FIGS. 6 and 7.

The UI 900 may also include a second setting 904 that is selectable to enable or configure the device to only provide app suggestions periodically consistent with present principles. For example, the setting 904 may be selected to set the device to allow messages concerning available apps to accumulate for a period of time, e.g., a day or a week, prior to presenting them to the user via the user device.

It is to be understood that whilst present principles have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

1. A first device, comprising:
at least one processor; and
storage accessible to the at least one processor and comprising instructions executable by the at least one processor to:
identify a location of a user device;
access a data structure correlating locations to applications;
using the location of the user device, identify at least a first application in the data structure;
identify a number of times the user device has previously been at the location, the number of times equaling at least one time;
responsive to the number of times satisfying a threshold, present a message on the user device alerting the user of the availability of the first application; and
responsive to the number of times not satisfying the threshold, not present the message on the user device.

2. The first device of claim 1, comprising a wireless transceiver accessible to the processor, a signal from the wireless transceiver being used to identify the location of the user device.

3. (canceled)

4. The first device of claim 1, wherein the first device comprises the user device.

5. The first device of claim 1, wherein the first device comprises a network server that communicates with the user device.

6. (canceled)

7. A computer readable storage medium (CRSM) that is not a transitory signal, the computer readable storage medium comprising instructions executable by at least one processor to:
identify a wireless signal from a computer electronics (CE) device received at a user device;
access a data structure correlating wireless signals to applications;
using the wireless signal from the CE device, identify at least a first application in the data structure;
identify a number of times the user device has previously detected the wireless signal, the number of times equaling at least one time;
responsive to the number of times satisfying a threshold, present a message on the user device alerting the user of the availability of the first application; and
responsive to the number of times not satisfying the threshold, not present the message on the user device.

8. (canceled)

9. The CRSM of claim 7, wherein the CRSM is embodied in the user device.

10. The CRSM of claim 7, wherein the CRSM is embodied in a network server that communicates with the user device.

11. (canceled)

12. A method, comprising:
identifying one or more of: a location of a user device, at least one characteristic of at least one wireless signal received by the user device;
based on identifying one or more of the location and the at least one characteristic, identifying a first application;
identifying a number of times the user device has previously been at the location;
responsive to the number of times satisfying a threshold, present a message on the user device alerting the user device that the first application is available for downloading; and
responsive to the number of times not satisfying the threshold, not present the message on the user device.

13. The method of claim 12, comprising identifying the location of the user device.

14. (canceled)

15. The method of claim 13, wherein the location comprises a place name.

16. (canceled)

17. The method of claim 12, comprising identifying the at least one characteristic of at least one wireless signal received by the user device.

18. The method of claim 17, wherein the at least one characteristic comprises a network address.

19. The method of claim 17, wherein the at least one characteristic comprises a wireless signal propagation characteristic.

20. The method of claim 12, wherein the message is presented on a display, and wherein the message comprises a selector that is selectable to initiate a download of the first application.

21. The first device of claim 1, wherein the threshold relates to a threshold number of times that the user device has previously been at the location within a predefined window of time.

22. The first device of claim 1, wherein the instructions are executable to:
present a user interface (UI) on a display of the user device, the UI comprising a setting that is selectable to set the user device to use respective user device locations to identify respective applications for which respective messages are to be presented alerting the user of the availability of the respective applications.

23. The CRSM of claim 7, wherein the threshold relates to a threshold number of times that the user device has previously detected the wireless signal within a predefined window of time.

24. The CRSM of claim 7, wherein the instructions are executable to:
present a user interface (UI) on a display, the UI comprising a setting that is selectable to set the user device to use respective user device locations to identify respective applications for which respective messages are to be presented alerting the user of the availability of the respective applications.

25. The method of claim 12, wherein the threshold relates to a threshold number of times that the user device has previously been at the location within a predefined window of time.

26. The method of claim 12, comprising:
presenting a user interface (UI) on a display, the UI comprising a setting that is selectable to set the user device to use respective user device locations to identify respective applications for which respective messages are to be presented alerting the user of the availability of the respective applications for download.
